(19) United States
(12) Patent Application Publication
(10) Pub. No.: US 2012/0175299 A1
(43) Pub. Date: Jul. 12, 2012

(54) HOLLOW FIBER MEMBRANES AND RELATED APPARATUSES AND METHODS

(75) Inventor: Matthias Maurer, Oberthal (DE)

(73) Assignee: FRESENIUS MEDICAL CARE DEUTSCHLAND GMBH, Bad Homburg (DE)

(21) Appl. No.: 13/344,306

(22) Filed: Jan. 5, 2012

Related U.S. Application Data
(60) Provisional application No. 61/431,231, filed on Jan. 10, 2011.

(30) Foreign Application Priority Data
Jan. 10, 2011 (DE) 102011008222.0

(51) Int. Cl. B01D 69/08; B29C 55/22; D01D 5/247

(52) U.S. Cl. 210/500.23; 264/209.3; 425/66

(57) ABSTRACT

A method that includes producing a strand by extruding a textile pulp at an extrusion rate that correlates with a first removal speed of the strand to generate a hollow fiber membrane, transporting the hollow fiber membrane at the first removal speed, and elongating the hollow fiber membrane by transporting the hollow fiber membrane at a second removal speed that is 0.5 to 50% higher than the first removal speed.

### CROSS-REFERENCE TO RELATED APPLICATIONS

This application claims the benefit of U.S. Application Ser. No. 61/431,231, filed on Jan. 10, 2011, and claims priority under 35 U.S.C. §119(a) to German Application No. 10 2011 008 222.0, filed on Jan. 10, 2011. Each of the above-noted applications is incorporated by reference herein.

### TECHNICAL FIELD

The present invention relates to hollow fiber membranes and related apparatuses and methods.

### BACKGROUND

In blood purification treatments, hollow fiber filter modules are used that include a hollow fiber bundle having several hollow fiber membranes. The module is divided into two chambers. One chamber includes internal regions of the hollow fibers and the inflow regions that conduct liquid to the internal regions of the fibers. The second chamber includes the region that surrounds the fibers and is separated from the inflow region of the first chamber. The purpose of the filter modules is to transfer substances through the membrane wall. During dialysis treatments (e.g., hemofiltration treatments and hemodiafiltration treatments), blood typically flows through the internal regions of the hollow fibers, and an exchange liquid (e.g., a dialysis solution) is located on the opposite side of the membrane in the second chamber.

The success of a blood treatment via filter modules is substantially dependent on the performance of the filter. The performance of the hollow fiber membranes can be described by the terms below. A measure for the material separation of a dialysis filter is given by the clearance (K):

$$K = {Q}_{Bi} \frac{{C}_{Bi} - {C}_{Bo}}{{C}_{Bi}} + {Q}_{F} \frac{{C}_{Bo}}{{C}_{Bi}} \qquad ( Equation 1 )$$

where QBi is the blood flow in, CBi is the concentration of an analyte in the blood flow in (concentration in) CBo is the concentration of the analyte in the blood flow out (concentration out), and QF is the filtration flow (i.e., the convective flow stream) through the membrane.

The material transport through the membrane wall can occur from the blood side to the dialysate side or from the dialysate side to the blood side according to various transport phenomena related to diffusion and convection. The driving force for diffusion is concentration differences in liquid or gaseous systems. In particular, small molecules play a large role in equilibrating the concentration since they are characterized by high particle movements. Large molecules, in contrast, carry out relatively small particle movements and are minimally transported through the membrane wall by diffusion.

The transmembrane transport of medium- and large-sized molecules can, in contrast, occur via convection. In the present system, the flow through the membrane wall forced by a transmembrane pressure (TMP) is termed convection. A pressure difference between the dialysate side and the blood side is caused by the flow rate and the flow direction of the two liquid circuits. The first term in Equation 1 describes the diffusive transport through the membrane. The second term describes the convective transport.

The transmembrane filtrate flow, also called the ultrafiltration rate QF, (and thus, the liquid flow that crosses over to the dialysate side or to the blood side) is proportional to the TMP in accordance with the following relationship:

Q_{F}=UF_{coeff}*TMP (Equation 2)

where UFcoeff is the ultrafiltration coefficient and TMP is the transmembrane pressure.

Accordingly, the filtrate flow QF increases as the ultrafiltration coefficient UFcoeff increases and/or as the transmembrane pressure TMP increases. In this context, UFcoeff is a measure of the permeability of the membrane, which relates to the surface of the membrane. Accordingly, the permeability increases as any of the number of pores, the membrane surface area, or the size of the pores increase.

An increase in the convective portion of the clearance and thus in the clearance can take place in accordance with Equation 2 by increasing the ultrafiltration coefficient or the transmembrane pressure. The transmembrane pressure can be affected by flow restrictions on either the blood side or the dialysate side of the membrane. In this manner, barriers can be installed in the streaming passages of the respective flow passages.

Furthermore, reducing the fiber diameter results in an increase in the transmembrane pressure (assuming constant blood and dialysate flows).

There are, however, limits to the increase in the transmembrane pressure. For example, hemolysis can occur if there is too large of a pressure difference between the blood and the dialysate sides. Such events are typically monitored on the machine side during a blood treatment since the transport of hemolysis fragments into a patient can be harmful to the patient. Accordingly, the treatment will generally be aborted when such events are possible. Furthermore, problems on the machine side can occur when pressures are too high. For example, such high pressures can increase the wear on the machine parts or disposable parts of the extracorporeal circuit.

Alternatively, the clearance can occur by increasing the ultrafiltration. The ultrafiltration coefficient is directly associated with the porosity. The porosity indicates the portion of the membrane surface that is porous. In some instances, it has been shown that the ultrafiltration rate is approximately proportional to the fourth power of the mean pore radius. An increase in the porosity thus results in an increase in the clearance (refer to Equation 2).

### SUMMARY

Certain methods described herein can be used to manufacture hollow fiber membranes having improved filtration performance and increased porosity.

In one aspect of the invention, a method for manufacturing a hollow fiber membrane includes producing a strand by extruding a textile pulp at an extrusion rate that correlates with a first removal speed of the strand to generate a hollow fiber membrane, transporting the hollow fiber membrane at the first removal speed, and elongating the hollow fiber membrane by transporting the hollow fiber membrane at a second removal speed that is 0.5 to 50% higher than the first removal speed.

In another aspect of the invention, a method for manufacturing a hollow fiber membrane includes extruding a textile pulp to produce a strand to generate a hollow fiber membrane, wherein the textile pulp includes a hydrophobic polymer having sulfur in a main polymer chain and a hydrophilic polymer. The method further includes elongating the hollow fiber membrane by 0.5 to 50%.

In an additional aspect of the invention, a method for manufacturing at least one hollow fiber membrane includes providing a textile pulp, extruding the textile pulp to produce at least one strand through at least one spinning nozzle having at least one cyclic extrusion gap at an extrusion rate which correlates with a first removal speed of the at least one strand, transporting the at least one hollow fiber membrane obtained from the at least one strand at the first removal speed; and elongating the at least one hollow fiber membrane by at least one means for elongating the hollow fiber membrane which effects a second removal speed higher by 0.5% to 50% (e.g., 5% to 30%, 5% to 20%, or 5% to 10%) in comparison with the first removal speed.

In a further aspect of the invention, a method for manufacturing at least one hollow fiber membrane includes providing a textile pulp, wherein the textile pulp includes a hydrophobic polymer with sulfur in the main chain and a hydrophilic polymer. The method further includes extruding the textile pulp to produce at least one strand through at least one spinning nozzle having at least one extrusion gap, wherein at least one hollow fiber membrane is obtained from the at least one strand. The method also includes elongating the at least one hollow fiber membrane by at least one means for elongating the hollow fiber membrane which effects an elongation of the hollow fiber membrane by 0.5% to 50% (e.g., 5% to 30%, 5% to 20%, or 5% to 10%).

Implementations can include one of more of the following features.

In some implementations, the hollow fiber membrane is elongated by using an upstream roller to transport the hollow fiber membrane at a first speed and using a downstream roller to transport the hollow fiber membrane at a second speed that exceeds the first speed. Elongating the hollow fiber membrane by increasing the removal speed of the hollow fiber membrane in this manner can be particularly advantageous. Increasing the removal speed by 0.5% to 50% allows the hollow fiber membrane to similarly be elongated by approximately 0.5% to 50%.

It has been shown that the sodium clearance can be increased by approximately 2.8% (in particular, from approximately 278 ml/min to approximately 286 ml/min) by elongating the hollow fiber membrane by 5%. Furthermore, it has been shown that the inulin clearance can be increased by approximately 3.8% (in particular, namely from approximately 132 ml/min to approximately 137 ml/min) by elongating the hollow fiber membrane by 5%. In such cases, measurement of the clearance values can be performed using methods known to one skilled in the art.

In some implementations, the extrusion gap has a circular cross section that is perpendicular to the extrusion direction of the textile pulp. Alternatively, the extrusion gap can have an annular, oval, or star-shaped cross section.

In certain implementations, the textile pulp includes a hydrophobic polymer having sulfur in the main polymer chain and a hydrophilic polymer.

In some implementations, the textile pulp is extruded through an extrusion gap of a spinning nozzle.

In some implementations, the extrusion gap is a circular extrusion gap.

In some implementations, the method further includes coextruding a precipitant through an extrusion opening that is surrounded by the extrusion gap, and coagulating the strand in a precipitation bath to form the hollow fiber membrane.

In certain implementations, the hydrophobic polymer having sulfur in the main polymer chain includes one or more of polysulfone (PSU) and polyethersulfone (PES), and the hydrophilic polymer includes polyvinylpyrrolidone (PVP).

In some implementations, the hollow fiber membrane is manufactured from textile pulp including PSU and PVP. It has been shown that pores of the hollow fiber membrane can become blocked by components of the textile pulp. Such blockages can occur, for example, when a phase inversion spinning process is used. The hollow fiber membrane can be elongated by 0.5% to 50% (e.g., 5% to 20% or 5% to 10%). Such elongation can, for example, be achieved by using an upstream roller to transport the hollow fiber membrane at a first speed and using a downstream roller to transport the hollow fiber membrane at a second speed that exceeds the first speed by 0.5% to 50% (preferably 5% to 20% or 5% to 10%). As a result, such that blockages are degraded and the permeability of the hollow fiber membrane is accordingly increased.

In certain implementations, the method for manufacturing the hollow fiber membrane can advantageously include a phase inversion spinning process.

In some implementations, the method further includes providing a precipitant, coextruding the precipitant through an extrusion opening that is surrounded by an extrusion gap through which the textile pulp is extruded, and coagulating the strand in a precipitation bath to form a hollow fiber membrane.

In certain implementations, the hollow fiber membrane is elongated by transport rollers that increase the removal speed of the hollow fiber membrane with respect to the removal speed of the strand.

In some implementations, the hollow fiber membrane is elongated by at least one curler that produces a wavy feature within the hollow fiber membrane. In certain implementations, such a curler can include at least two toothed curler rollers that can, for example, each have a diameter of approximately 60-80 mm (e.g., approximately 70 mm). In certain implementations, each curler roller has approximately 25-35 teeth (e.g., 30 teeth). The curler rollers can be constructed in the same manner.

In some implementations, the hollow fiber membrane is elongated by at least one slide rail via which the hollow fiber membrane is deflected from a transport direction of the hollow fiber membrane. Thus, it is possible to deflect adjacent tracks of hollow fiber membranes via fixed steel rails (e.g., within a region downstream of the curler or upstream of a winding means for the hollow fiber membranes, such as a bobbin). In certain implementations, a deflection of adjacent tracks occurs at three hollow fiber membranes. A path length difference Δ1 results and corresponds to λ/3 of the wave feature of hollow fiber membranes having a wavelength λ (i.e., as produced by, for example, the curler). In this manner, a path length difference of λ/3 is produced between track 1 and track 2, and a path length difference of 2*λ/3 is produced between track 1 and track 3. Accordingly, there is no offset between track 1 and track 4, and additional tracks follow the same principles. In some examples, the sodium clearance can be increased by 4 ml/min by this elongation.

In another aspect of the invention, a hollow fiber membrane (or a bundle of hollow fiber membranes) is manufactured using the above-described methods. The hollow fiber membrane or membranes, during the manufacturing process, is/are elongated by 0.5% to 50% (e.g., 5% to 20% or 5% to 10%).

In some implementations, the hollow fiber membrane has a wavy feature.

In another aspect of the invention, an apparatus is configured to carry out the above-described methods.

In one aspect of the invention, an apparatus includes an extruder including a spinning nozzle defining an extrusion gap through which a textile pulp can be extruded to form a strand used to generate a hollow fiber membrane, and a device configured to elongate the hollow fiber membrane by 0.5 to 50%.

In certain implementations, the apparatus includes a spinning zone configured to extrude textile pulp through an extrusion gap of a spinning nozzle. The apparatus is configured to extrude the textile pulp at an extrusion rate correlating with a removal speed of a strand formed from the extruded textile pulp. In some implementations, the extrusion gap is a circular extrusion gap.

In some implementations, the apparatus is further configured to coextrude a precipitant through an extrusion opening surrounded by the extrusion gap. In certain implementations, the apparatus includes at least one rinsing bath such that at least one precipitation bath is provided within which a strand can be coagulated to form the hollow fiber membrane.

In some implementations, the rinsing bath is positioned downstream of the spinning zone.

In certain implementations, the apparatus includes at least one drying zone in which the hollow fiber membrane can be dried.

In some implementations, the drying zone is positioned downstream of the at least one rinsing bath, and the apparatus further includes one or more drying chambers.

In certain implementations, the apparatus further includes a component for elongating the hollow fiber membrane.

In some implementations, the component includes one or more transport rollers that run at a speed causing the hollow fiber membrane to be transported at a removal speed that is higher than the removal speed of the strand.

In certain implementations, the component includes at least one curler that produces a wavy feature within the hollow fiber membrane.

In some implementations, the component includes at least one slide rail configured to deflect the hollow fiber membrane from a transport direction of the hollow fiber membrane.

In certain implementations, the component includes at least one bobbin configured to elongate the hollow fiber membrane.

In some implementations, the apparatus includes a control unit (e.g., a microprocessor) that controls the extruder, the one or more transport rollers, the at least one curler, the at least one slide rail, and/or the at least one bobbin in a manner to produce a desired elongation of the hollow fiber membrane.

Other aspects, features, and advantages will be apparent from the description, the drawings, and the claims.

### DESCRIPTION OF DRAWINGS

FIG. 1 is a schematic of an apparatus for manufacturing a hollow fiber membrane.

FIG. 2 schematically illustrates a process of elongating the hollow fiber membrane using the apparatus of FIG. 1.

FIG. 3 is a front view of a curler roller of the apparatus of FIG. 1.

FIG. 4 is a schematic view of the hollow fiber membrane extended between teeth of curler rollers of the apparatus of FIG. 1.

### DETAILED DESCRIPTION

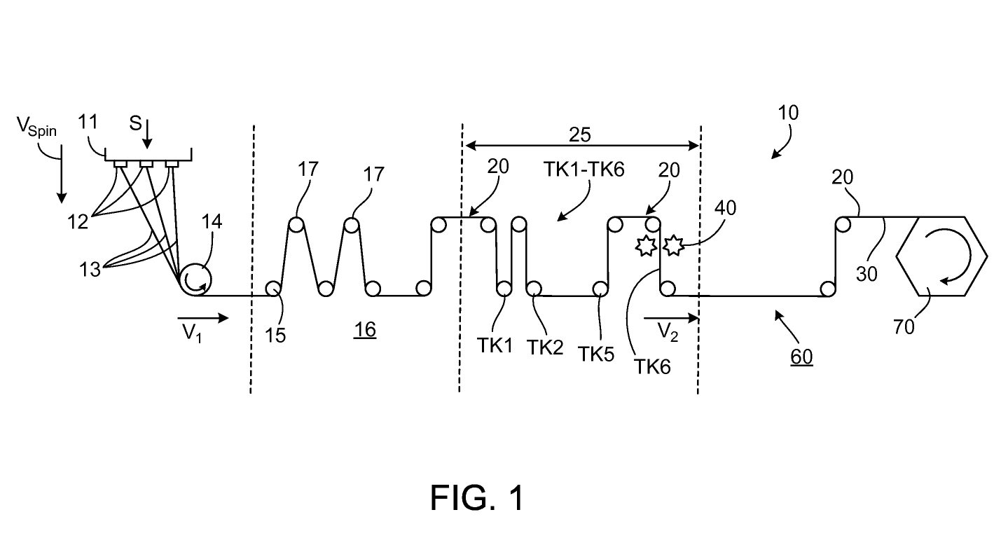

FIG. 1 illustrates an apparatus 10 for manufacturing a hollow fiber membrane bundle 30 that is formed of several hollow fiber membranes 20. In a process carried out using the apparatus 10, several threads or strands 13 can be spun at a time. The stands 13, as will be described below, are formed into the hollow fiber membranes 20 and bundled together.

Still referring to FIG. 1, a textile pulp S is extruded in a spinning zone of the apparatus 10 through extrusion gaps 12 at a speed Vₛₚᵢₙₙ by a spinning block including three spinning nozzles 11. An extrusion rate of a first removal speed V₁ of the strands 13 correlates with the action of the spinning nozzles 11. The spinning process carried out using the apparatus 10 is referred to as a phase inversion spinning process.

The textile pulp S includes a hydrophobic polymer that has sulfur in the main polymer chain and a hydrophilic polymer. In some implementations, the textile pulp S includes polysulfone (PSU) and polyvinylpyrrolidone (PVP). A precipitant is further provided and is coextruded through extrusion openings that are surrounded by the extrusion gaps 12. The strands 13 are placed within a precipitation bath where they coagulate to form the hollow fiber membranes 20. The resulting hollow fiber membranes 20 are then transported to a rinsing zone 16 and are transported through rinsing baths via transport rollers 14, 15 at the first removal speed V₁.

The hollow fiber membranes 20 are then further conducted to a drying zone 25 including drying chambers TK1-TK6 in which the hollow fiber membranes 20 are dried and elongated by 5 to 10% or 10 to 20%.

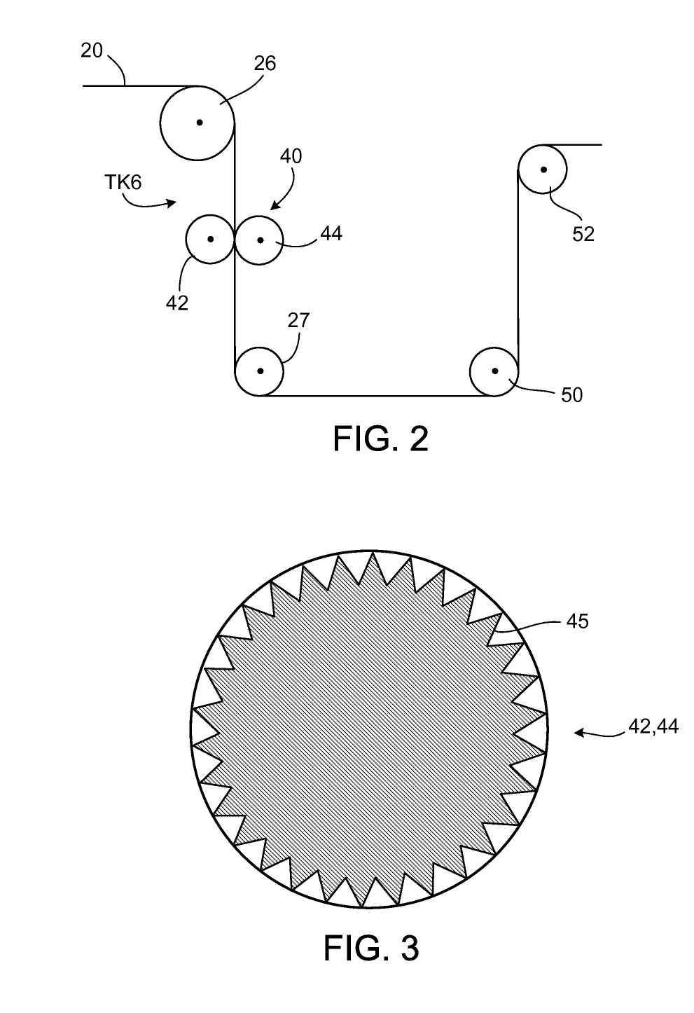

As shown in FIG. 2, the hollow fiber membranes 20 within the last drying chamber TK6 are transported through a curler 40 including curler rollers 42, 44 having the same construction. Two rollers 50, 52 are located external to the drying chamber TK6 for removing the hollow fiber membranes 20 from the drying chamber TK6.

A roller 26 that is located upstream of the curler rollers 42, 44 and used to convey the hollow fiber membranes 20 into the nip formed between the curler rollers 42, 44 runs at a removal speed of approximately 410 mm/s, while a roller 27 that is located downstream of the curler rollers 42, 44 and used to facilitate removal of the hollow fiber membranes 20 from the nip formed between the curler rollers 42, 44 runs at a removal speed of approximately 415 mm/s. Due to the differing speeds of the rollers 26, 27, the hollow fiber membranes 20 are elongated by approximately 1% by the rollers 26, 27 independent of the curler 40.

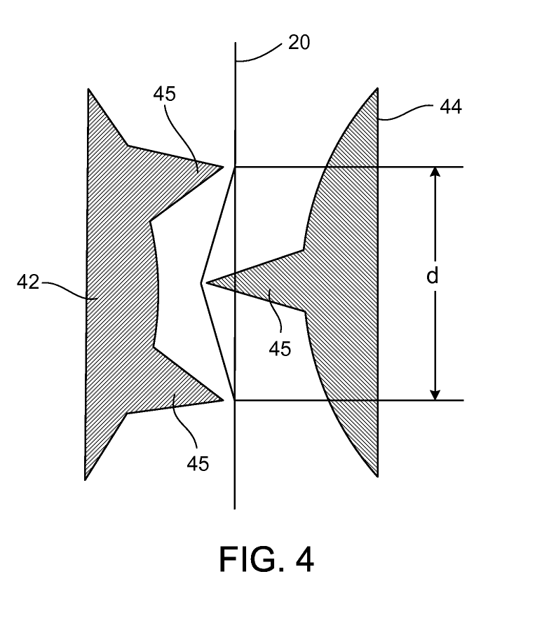

FIG. 3 shows a front view of curler rollers 42, 44 including 30 teeth. FIG. 4 schematically illustrates the hollow fiber membrane 20 extended between the teeth of the curler rollers 42, 44, where d is a distance between two adjacent teeth tips 45.

A wavy feature is formed within the hollow fiber membranes 20 while the hollow fiber membranes 20 pass through the curler 40 and thus elongates the hollow fiber membranes 20. Due to the elongation of the hollow fiber membranes 20, a removal speed V₂ of the elongated hollow fiber membranes 20 is higher than the removal speed V₁ of the strand 13. Typically, the removal speed V₂ is 0.5 to 50% higher than the removal speed V₁, and the hollow fiber membranes 20 are elongated by approximately the same amount (i.e., by 0.5 to 50%). In some implementations, the removal speed V₂ is 5 to 20% higher than the removal speed V₁.

Past the curler 40, the hollow fiber membranes 20 are transported via sliding rails 60. The sliding rails 60 are typically bars that are offset from the plane in which a roller upstream and a roller downstream of the sliding rail 60 are positioned. Due to this offset, the hollow fiber membranes 20 that are transported along each sliding rail are deflected out of the plane of the upstream and downstream rollers and thus become elongated.

Adjacent tracks of hollow fiber membranes 20 are thus deflected. In the example of FIGS. 1-4, a deflection of adjacent tracks occurs at three hollow fiber membranes 20. A path length difference Δ1 results and corresponds to λ/3 of the wave feature of the hollow fiber membrane 20, where λ is a wavelength produced by the curler 40. In this manner, a path length difference of λ/3 is produced between track 1 and track 2, and a path length difference of 2*λ/3 is produced between track 1 and track 3. Accordingly, there is no offset between track 1 and track 4, and additional tracks follow the same principles. The hollow fiber bundle strand 30 formed from the hollow fiber membranes 20 is then conducted to a bobbin 70 where it is wound up so that it can be cut to form uniformly sized hollow fiber bundles.

While certain implementations have been described, other implementations are possible.

While the methods described above include extruding multiple strands 30 that are formed into multiple hollow fiber membranes 20, it is possible to extrude only a single strand 30 to form a single hollow fiber membrane 20.

While the spinning block has been described as including three spinning nozzles 11, more or fewer spinning nozzles can be used depending on the desired number of hollow fiber membranes 20 to be formed.

While the methods described above include using several different techniques, including the disparity of removal rates, a curler, sliding rails, and a bobbin, to elongate the hollow fiber membranes 20, any subset of those techniques can be used to elongate the hollow fiber membranes 20. In certain implementations, only one of those techniques is used to elongate the hollow fiber membranes 20.

Other embodiments are within the scope of the following claims.

What is claimed is:

1. A method, comprising:
producing a strand by extruding a textile pulp at an extrusion rate that correlates with a first removal speed of the strand to generate a hollow fiber membrane;
transporting the hollow fiber membrane at the first removal speed; and
elongating the hollow fiber membrane by transporting the hollow fiber membrane at a second removal speed that is 0.5 to 50% higher than the first removal speed.

2. The method of claim 1, wherein the textile pulp includes a hydrophobic polymer having sulfur in a main polymer chain and a hydrophilic polymer.

3. The method of claim 2, wherein the hydrophobic polymer having sulfur in the main polymer chain includes one or more of polysulfone (PSU) and polyethylene sulfone (PES), and wherein the hydrophilic polymer includes polyvinylpryyolidone (PVP).

4. The method of claim 1, wherein the textile pulp is extruded through an extrusion gap of a spinning nozzle.

5. The method of claim 4, further comprising:
coextruding a precipitant through an extrusion opening that is surrounded by the extrusion gap; and
coagulating the strand in a precipitation bath to form the hollow fiber membrane.

6. The method of claim 1, wherein the hollow fiber membrane is elongated by transporting the hollow fiber membrane on transport rollers that run at a speed that causes the hollow fiber membrane to be transported at a removal speed that is higher than a removal speed of the strand.

7. The method of claim 1, wherein the hollow fiber membrane is elongated by at least one curler that produces a wavy feature within the hollow fiber membrane.

8. The method of claim 1, wherein the hollow fiber membrane is elongated by at least one sliding rail via which the hollow fiber membrane is deflected from a transport direction of the hollow fiber membrane.

9. The method of claim 1, wherein the method comprises:
producing a plurality of strands by extruding the textile pulp to generate a plurality of hollow fiber membranes; and
elongating the plurality of hollow fiber membranes.

10. A hollow fiber membrane manufactured using the method of claim 1.

11. A bundle of hollow fiber membranes manufactured using the method of claim 9.

12. A method, comprising:
extruding a textile pulp to produce a strand to generate a hollow fiber membrane, wherein the textile pulp includes a hydrophobic polymer having sulfur in a main polymer chain and a hydrophilic polymer; and
elongating the hollow fiber membrane by 0.5 to 50%.

13. The method of claim 12, wherein the method comprises:
extruding the textile pulp to produce a plurality of strands to generate a plurality of hollow fiber membranes; and
elongating the plurality of hollow fiber membranes by 0.5 to 50%.

14. An apparatus, comprising:
an extruder comprising a spinning nozzle defining an extrusion gap through which a textile pulp can be extruded to form a strand used to generate a hollow fiber membrane; and
a device configured to elongate the hollow fiber membrane by 0.5 to 50%.

15. The apparatus of claim 14, wherein the extruder is configured to extrude the textile pulp at an extrusion rate correlating with a removal speed of the strand.

16. The apparatus of claim 14, wherein the extruder comprises an extrusion opening that is surrounded by the extrusion gap and through which a precipitant can be coextruded with the textile pulp.

17. The apparatus of claim 16, further comprising a precipitation bath in which the strand can be coagulated to form the hollow fiber membrane.

18. The apparatus of claim 17, wherein the precipitation bath is positioned downstream of the extruder.

19. The apparatus of claim 17, further comprising a drying zone in which the hollow fiber membrane can be dried.

20. The apparatus of claim 19, wherein the drying zone is positioned downstream of the precipitation bath.

21. The apparatus of claim 14, wherein the device configured to elongate the hollow fiber membrane comprises a first transport roller configured to transport the hollow fiber membrane at a first removal speed and a second transport roller configured to transport the hollow fiber membrane at a second removal speed that is higher than the first removal speed.

22. The apparatus of claim 14, wherein the device configured to elongate the hollow fiber membrane comprises a curler configured to produce a wavy feature within the hollow fiber membrane.

23. The apparatus of claim 14, wherein the device configured to elongate the hollow fiber membrane comprises at least one sliding rail configured to deflect the hollow fiber membrane from a transport direction of the hollow fiber membrane.

24. The apparatus of claim 14, herein the device configured to elongate the hollow fiber membrane comprises a bobbin.
